(19) United States
(12) Patent Application Publication
(10) Pub. No.: US 2022/0172255 A1
(43) Pub. Date: Jun. 2, 2022

(54) CONFIDENT PROCESSING OF VALUATIONS FROM DISTRIBUTED MODELS SYSTEMS AND METHODS

(71) Applicant: Zillow, Inc., Seattle, WA (US)

(72) Inventors: Bin He, Seattle, WA (US); Taylor McKay, Seattle, WA (US); Mo Zhang, Seattle, WA (US); Xan Vongsathorn, Seattle, WA (US); Andrew Martin, Seattle, WA (US)

(21) Appl. No.: 17/536,929

(22) Filed: Nov. 29, 2021

Related U.S. Application Data
(60) Provisional application No. 63/120,064, filed on Dec. 1, 2020.

(51) Int. Cl. G06Q 30/02

(52) U.S. Cl. CPC G06Q 30/0278

(57) ABSTRACT

Confidence-boosted automated valuation systems and methods for performing confident processing of valuations from automated valuation models are disclosed. The confidence-boosted automated valuation system uses home/model data, actual values, and predicted values of homes to train a confidence model to produce confidence scores. The system can partition the homes into confident bins each containing homes with similar confidence scores. To generate a confidence score for a predicted value of a subject home, the confidence-boosted automated valuation system can apply the trained confidence model to the subject home. Using the generated confidence score, the confidence-boosted automated valuation system can identify a confidence bin the subject home falls in. The confidence-boosted automated valuation system can compute a predicted error in the predicted value of the subject home using the confidence bin. Based on the predicted error, the confidence-boosted automated valuation system can determine whether the predicted value is a confident home value.

### CROSS REFERENCE TO RELATED APPLICATION(S)

This application claims the benefit of U.S. Provisional Application No. 63/120,064, filed on Dec. 1, 2020, the contents of which are incorporated by reference in its entirety.

### BACKGROUND

In many roles, it can be useful to be able to accurately determine the value of residential real estate properties (“homes”). A variety of conventional approaches exist for valuing homes. For a home that was very recently sold, one approach is attributing its sale price as its value. Another widely used conventional approach to valuing homes is appraisal, where a professional appraiser determines a value for a home by comparing some of its attributes to the attributes of similar nearby homes that have recently sold (“comparable homes” or “comps”). The appraiser arrives at an appraised value by subjectively adjusting the sale prices of the comps to reflect differences between the attributes of the comps and the attributes of the home being appraised, then aggregating these adjusted sale prices, such as by determining their mean. A further widely used conventional approach to valuing houses involves statistical methods. Historical home sale transactions can be used together with attributes (e.g., location, age, size, construction, style, condition) of the sold homes to construct a model capable of predicting the value of an arbitrarily selected home based upon its attributes. This model can then be applied to the attributes of any home in order to estimate the value of this home.

### BRIEF DESCRIPTION OF THE DRAWINGS

FIG. 1 is a block diagram showing some of the components typically incorporated in at least some of the computer systems and other devices on which the disclosed system operates in accordance with some implementations of the present technology.

FIG. 2 is a system diagram illustrating an example of a computing environment in which the disclosed system operates in some implementations of the present technology.

FIG. 3 is a block diagram illustrating components of a confidence-boosted automated valuation system in accordance with some implementations of the present technology.

FIG. 4 is a flow diagram illustrating a process of training a confidence model to produce confidence scores in accordance with some implementations of the present technology.

FIG. 5 is a flow diagram illustrating a process of confidence binning in accordance with some implementations of the present technology.

FIG. 6 is a flow diagram illustrating a process of determining homes with confident homes values in accordance with some implementations of the present technology.

FIG. 7 is a flow diagram illustrating a process of processing predicted values and/or confidence scores of homes generated by multiple models in accordance with some implementations of the present technology.

FIG. 8 is a conceptual diagram illustrating an example of interquartile ranges of actual values of comparable homes in accordance with some implementations of the present technology.

FIG. 9 is a conceptual diagram illustrating examples of confidence bins and error distributions of confidence scores in accordance with some implementations of the present technology.

FIG. 10 is a conceptual diagram illustrating an example of the errors of confident home values in accordance with some implementations of the present technology.

FIG. 11 is a conceptual diagram illustrating an example of a confident home value offering in accordance with some implementations of the present technology.

In the drawings, some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the specific implementations described. On the contrary, the technology is intended to cover all modifications, equivalents, and alternatives falling within the scope of the technology as defined by the appended claims.

### DETAILED DESCRIPTION

An automated valuation model (AVM) is a type of statistical or machine learning-based model that can be used to generate a valuation or predicted price for a home (used herein as “predicted value”). Although an automated valuation model attempts to generate a predicted value that is as close to what the actual value (e.g., actual sale price, list price, inferred sale price, adjusted sale price) of the home is (e.g., home has already been listed or sold) or may be (e.g., home is to be listed or sold), not every predicted value is certain/confident or necessarily close to what the actual value is or will be. The confidence in the predicted value of each individual home can be very different from one another, and homes that are easier to predict or value can be hard to separate from harder to value homes. In some instances, different automated valuation models can generate different or disparate predicted values, making it difficult to determine which model is actually trustworthy and/or accurate. Some of those models may be explainable/interpretable and easier to fine-tune, while others a complete black box, making it difficult to adjust such models to generate more certain predicted values. Due to such complications, attempting to fully automate the home valuation process is challenging. Many current methodologies utilize at least some human involvement, such as an appraiser or analyst evaluating or verifying whether the predicted value generated from an automated valuation model is certain or confident enough to be presented to sellers or buyers. Existing systems and methods also require heavy amounts of computations, processing power, and networking bandwidth to evaluate large datasets of home transactions obtained from various remote data sources and to then generate a valuation.

There is a need for methods and systems that can autonomously determine predicted values of homes in a confident and robust fashion. These needs become even more critical when an entity using an automated valuation model is a buyer that would like to offer a confident price at which to purchase a home from a seller. In such instances, it can be important for the entity to make sure they are offering a reasonable price that is certain enough to be close to the actual value of the home. Conventional processes may provide ways to generate valuations for various different types of homes, but there is a lack of methods that can model the confidence in predicted values of homes and then rank them according to an expected pricing error from the actual values of the homes.

To overcome these and other deficiencies of existing systems, the inventors have developed an automated system for performing confident processing of valuations from automated valuation models (the “confidence-boosted automated valuation system”). The automation valuation models can be distributed across various different systems or entities used to train and/or test the models. Moreover, the predicted values of homes generated by the automated valuation models can be distributed across various different databases/data stores. Although the discussion here is in the context of a home, the confidence-boosted automated valuation system can apply to other property types (e.g., residential properties, commercial properties, land, rental properties, lots of land, new homes, etc.).

In various implementations, the confidence-boosted automated valuation system can obtain the predicted values of homes generated by the automated valuation models. Using the predicted values, the confidence-boosted automated valuation system can learn from the errors in the predicted values (e.g., how different the predicted values are from actual values of homes) made by the models. By learning from past errors, the confidence-boosted automated valuation system can predict certainties or confidences for the predicted value of a home in the form of a confidence score and/or a predicted pricing error distribution. In other words, the confidence-boosted automated valuation system can model how hard it is for an automated valuation model to predict the actual value of a home and how confident the model is in its prediction. The confidence-boosted automated valuation system can then select homes with the most confident or smallest error in predicted value as homes eligible to be offered the automated valuation to a seller or buyer (e.g., presented via a home display page of a website or user experience page displayed on the graphical user interface (GUI) of a user computing or mobile device). Accordingly, the confidence-boosted automated valuation system can identify confident predicted values of homes (e.g., homes less risky to automate offers for with the predicted value as a gross value) and reduce the risk of offering homes that have less certainty or confidence in the predicted value.

By automating the process for producing predicted values that are confident and certain, the confidence-boosted automated valuation system removes the involvement of analysts or appraisers, thereby making the valuation process less time-consuming, less labor intensive, and more scalable. Since many automated valuation model algorithms optimize for the best overall accuracy of all homes, they tend to produce a predicted value for a specific home regardless of whether the specific home is easy to valuate for the algorithm and the data source used. The confidence-boosted automated valuation system is able to check the degree of difficulty of confidence an automated valuation model had in producing the predicted value for the specific home, and thus return valuable feedback as to what models generate better predictions for certain homes. For homes that tend to have a large error, existing systems and methods have difficulties in determining how much the error or offset is, as well as the direction of the offset or error. Even then, being able to correct for the error does not necessarily help identify more confident valuations of homes. The confidence-boosted automated valuation system, though, is able to learn the error in predicted values even for homes with large errors, and then evaluate the error to determine those predicted values that are confident predictions by the model. The confidence-boosted automated valuation system is thus able to address whether an automated valuation model's predicted price for a specific home is confident/certain, which can be described as a form of certainty modeling. By triaging uncertain predicted values, the confidence-boosted automated valuation system can deliver the most confident predicted values of homes (e.g., those very close to the actual value or what the actual value may be) to end users such as sellers/buyers of homes.

The confidence-boosted automated valuation system provides increased visibility or coverage of home valuations since predicted values of homes that sellers/buyers may otherwise not be willing to offer can now be confidently offered. The confidence-boosted automated valuation system also helps expand the market for the home buying/selling business as well as expanding same store growth (e.g., more transactions within existing markets) and future store growth (e.g., new markets). Since the confidence-boosted automated valuation system offers homes with confident predicted values, the outputted offer is one that a seller or buyer would likely be willing to sell or buy it for, respectively. Consequently, the confidence-boosted automated valuation system can reduce time, costs, and throwaway work by focusing on confident predicted values of homes. For example, the confidence-boosted automated valuation system can reduce analyst time while still ensuring good accuracy for automated valuations. Such reductions can result in reduced usage of computing resources, storage space, and networking latency since valuations that ultimately are not confident and undesirable for buyers/sellers can be filtered out to not be further processed. The increased efficiencies can result in computing systems and networking devices being able to increase execution speed and delivery to entities seeking home valuations. Moreover, because the confidence-boosted automated valuation system can determine those predicted values that are confident, it can place less burden on having to train automated valuation models that are generalizable, very accurate/precise, computationally expensive, and data hungry. Accordingly, fewer training examples need to be provided since the confidence-boosted automated valuation system can provide additional feedback as to how the automated valuation model is performing and adjust thereof. The confidence-boosted automated valuation system thus can allow both upstream and downstream systems to use fewer, less powerful, and less costly computing devices, along with fewer, less capacious, and less costly storage devices.

### Suitable Computing Environments

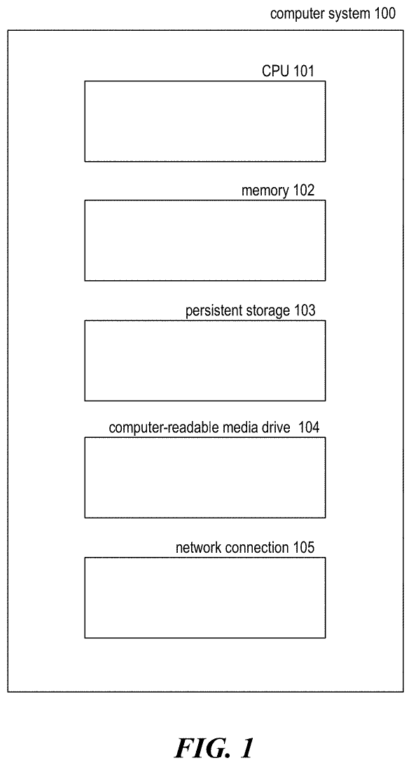

FIG. 1 is a block diagram showing some of the components typically incorporated in at least some of the computer systems and other devices on which the disclosed system operates. In various embodiments, these computer systems and other devices 100 can include server computer systems, desktop computer systems, laptop computer systems, netbooks, mobile phones, personal digital assistants, televisions, cameras, automobile computers, electronic media players, web services, mobile devices, watches, wearables, glasses, smartphones, tablets, smart displays, virtual reality devices, augmented reality devices, etc. In various embodiments, the computer systems and devices include zero or more of each of the following: a central processing unit (CPU) 101 for executing computer programs; a computer memory 102 for storing programs and data while they are being used, including the facility and associated data, an operating system including a kernel, and device drivers; a persistent storage device 103, such as a hard drive or flash drive for persistently storing programs and data; computer-readable media drives 104 (e.g., at least one non-transitory computer-readable medium) that are tangible storage means that do not include a transitory, propagating signal, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

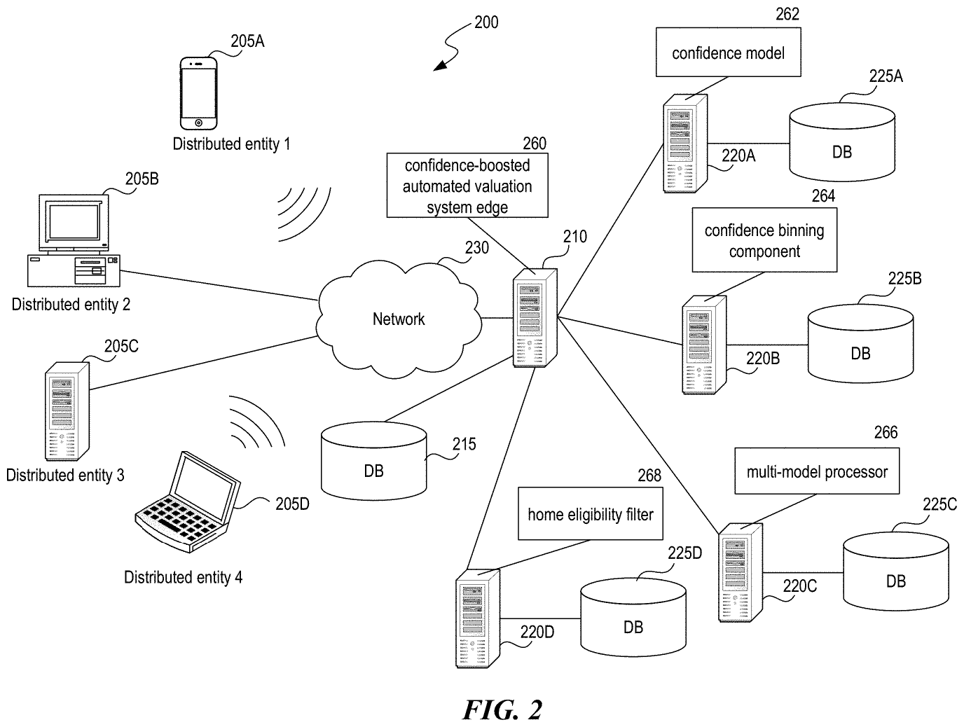

FIG. 2 is a system diagram illustrating an example of a computing environment in which the disclosed system operates in some embodiments. In some embodiments, environment 200 includes one or more client computing devices 205A-D, examples of which can host the system 100. For example, the computing devices 205A-D can comprise distributed entities 1-4, respectively. Client computing devices 205 operate in a networked environment using logical connections through network 230 to one or more remote computers, such as a server computing device.

In some embodiments, server 210 is an edge server which receives client requests and coordinates fulfillment of those requests through other servers, such as servers 220A-D. For example, the server 210 can comprise a confidence-boosted automated valuation system edge 260 that receives client requests from the distributed entities 1-4 and coordinates fulfillment of those requests through servers 220A-D, which can comprise the confidence-boosted automated valuation system. The servers 220A-D can each comprise components of the confidence-boosted automated valuation system, such as a confidence model 262, a confidence binning component 264, a multi-model processor 266, and a home eligibility filter 268. In some embodiments, server computing devices 210 and 220 comprise computing systems, such as the system 100. Though each server computing device 210 and 220 is displayed logically as a single server, server computing devices can each be a distributed computing environment encompassing multiple computing devices located at the same or at geographically disparate physical locations. In some embodiments, each server 220 corresponds to a group of servers.

Client computing devices 205 and server computing devices 210 and 220 can each act as a server or client to other server or client devices. In some embodiments, servers (210, 220A-D) connect to a corresponding database (215, 225A-D). As discussed above, each server 220 can correspond to a group of servers, and each of these servers can share a database or can have its own database. Databases 215 and 225 warehouse (e.g., store) information such as home information, recent sales, home attributes, particular homes, subject homes, comparable homes, home data, actual values of homes, predicted values of homes, automated valuation models, model data, training data, test data, validation data, confidence scores, predicted errors, one or more machine learning models, confidence models, confidence bins, partitions of homes, error distributions, conversion functions, confident home values, confident homes, updated confidence scores, updated predicted values of homes, calibrated confidence scores, calibration models, isotonic regression models, confidence selector models, most confident predicted values, ensemble models, synthetization/aggregation functions, not-easily-explainable or not-easily-interpretable models, explainable or interpretable models, confident valuation models, predefined ranges, predefined thresholds, error thresholds, graphical representations, requests for valuations, interquartile ranges of actual values, quantiles of actual values, upper quartiles of actual values, lower quartiles of actual values, bin threshold values, market or location, time or seasons, types of homes, model performance, confidence bin performance, sale prices, listing prices, and so on.

The one or more machine learning models can include supervised learning models, unsupervised learning models, semi-supervised learning models, and/or reinforcement learning models. Examples of machine learning models suitable for use with the present technology include, but are not limited to: regression algorithms (e.g., ordinary least squares regression, linear regression, logistic regression, stepwise regression, multivariate adaptive regression splines, locally estimated scatterplot smoothing), instance-based algorithms (e.g., k-nearest neighbor, learning vector quantization, self-organizing map, locally weighted learning, support vector machines), regularization algorithms (e.g., ridge regression, least absolute shrinkage and selection operator, elastic net, least-angle regression), decision tree algorithms (e.g., classification and regression trees, Iterative Dichotomiser 3 (ID3), C4.5, C5.0, chi-squared automatic interaction detection, decision stump, M5, conditional decision trees), Bayesian algorithms (e.g., naïve Bayes, Gaussian naïve Bayes, multinomial naïve Bayes, averaged one-dependence estimators, Bayesian belief networks, Bayesian networks), clustering algorithms (e.g., k-means, k-medians, expectation maximization, hierarchical clustering), association rule learning algorithms (e.g., apriori algorithm, ECLAT algorithm), artificial neural networks (e.g., perceptron, multilayer perceptrons, back-propagation, stochastic gradient descent, Hopfield networks, radial basis function networks), deep learning algorithms (e.g., convolutional neural networks, recurrent neural networks, long short-term memory networks, stacked auto-encoders, deep Boltzmann machines, deep belief networks), dimensionality reduction algorithms (e.g., principle component analysis, principle component regression, partial least squares regression, Sammon mapping, multidimensional scaling, projection pursuit, discriminant analysis), time series forecasting algorithms (e.g., exponential smoothing, autoregressive models, autoregressive with exogenous input (ARX) models, autoregressive moving average (ARMA) models, autoregressive moving average with exogenous inputs (ARMAX) models, autoregressive integrated moving average (ARIMA) models, autoregressive conditional heteroskedasticity (ARCH) models), and ensemble algorithms (e.g., boosting, bootstrapped aggregation, AdaBoost, blending, stacking, gradient boosting machines, gradient boosted trees, random forest).

In various implementations, the one or more machine learning models can be trained on training data or a training set. The training data or training set can be created by generating pairs of features (e.g., feature vectors) and/or ground-truth labels/values based on any of the data stored in databases 215 and 225. During training, the machine learning models can be adjusted or modified to fit the models to the training data by, e.g., adjusting or modifying model parameters, such as weights and/or biases, so as to minimize some error measure (e.g., a difference between a predicted value and an actual/ground-truth value) over the training data. The error measure can be evaluated using one or more loss functions. Examples of loss functions that can be used include, but are not limited to, cross-entropy loss, log loss, hinge loss, mean square error, quadratic loss, L2 loss, mean absolute loss, L1 loss, Huber loss, smooth mean absolute error, log-cosh loss, or quantile loss. The trained machine learning models can then be applied to test data or validation data (e.g., holdout dataset) to generate predictions (e.g., predicted values or labels). The test data or validation data can also come from data that is stored in databases 215 and 225 (e.g., unlabeled data to generate predictions for). In some implementations, the machine learning models can be retrained to further modify/adjust model parameters and improve model performance. The machine learning models can be retrained on existing and/or new training data, training data, or validation data so as to fine-tune the model parameters to better fit the data and yield a different error measure over the data (e.g., further minimization of the error, or to increase the error to prevent overfitting). More specifically, the model can be further adjusted or modified (e.g., fine-tuned model parameters such as weights and/or biases) so as to alter the yielded error measure. Such retraining can be performed iteratively whenever it is determined that adjustments or modifications to the machine learning models are desirable.

Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but can also be other wired or wireless networks. In some embodiments, network 230 is the Internet or some other public or private network. Client computing devices 205 are connected to network 230 through a network interface, such as by wired or wireless communication. While the connections between server 210 and servers 220 are shown as separate connections, these connections can be any kind of local, wide area, wired, or wireless network, including network 230 or a separate public or private network.

### Confidence-Boosted Automated Valuation System

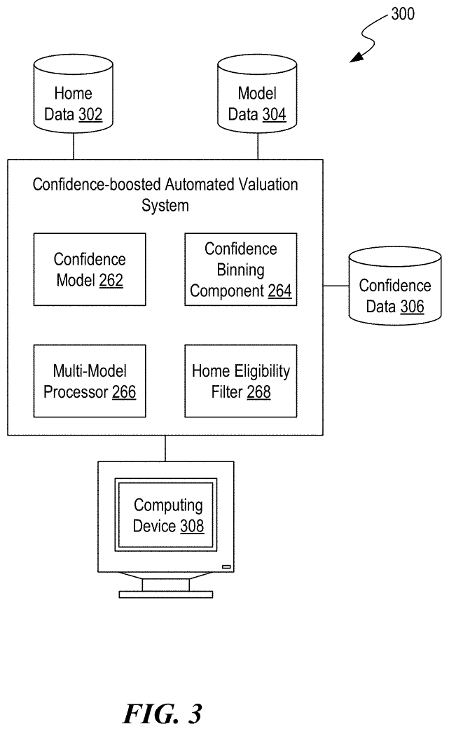

FIG. 3 is a block diagram illustrating components of a confidence-boosted automated valuation system 300 in accordance with some implementations of the present technology. The confidence-boosted automated valuation system 300 can include the confidence model 262, the confidence binning component 264, the multi-model processor 266, and the home eligibility filter 268 described in relation to FIG. 2.

The confidence model 262 can be a machine learning or statistical model trained to generate confidence scores for predicted values of homes. The predicted values of homes can be generated by one or more automated valuation models and stored in the home data store 302 (e.g., the predicted value is generated by one of the automated valuation models, generated by an ensemble of the one or more automated valuation model, or generated by synthesizing the predicted values from the one or more automated valuation models via a mean, median, weighted mean, or weighted median). The following applications, each of which is hereby incorporated by reference in its entirety, describe examples of automated valuation models that can be employed to generate predicted values of homes: U.S. patent application Ser. No. 17/322,208 filed on May 17, 2021, U.S. patent application Ser. No. 16/951,900 filed on Nov. 18, 2020, U.S. patent application Ser. No. 11/971,758 (now U.S. Pat. No. 8,140,421) filed on Jan. 9, 2008, U.S. patent application Ser. No. 11/347,000 (now U.S. Pat. No. 8,676,680) filed on Feb. 3, 2006, U.S. patent application Ser. No. 11/347,024 (now U.S. Pat. No. 7,970,674) filed on Feb. 3, 2006, U.S. patent application Ser. No. 11/524,047 (now U.S. Patent Publication No. 2008/0077458) filed on Sep. 19, 2006, U.S. patent application Ser. No. 11/524,048 (now U.S. Pat. No. 8,515,839) filed on Sep. 19, 2006, U.S. patent application Ser. No. 11/971,758 (now U.S. Pat. No. 8,140,421) filed on Jan. 9, 2008, U.S. patent application Ser. No. 13/797,363 (now U.S. Pat. No. 9,361,583) filed on Mar. 12, 2013, U.S. patent application Ser. No. 13/828,680 filed on Mar. 14, 2013, U.S. patent application Ser. No. 14/078,076 (now U.S. Pat. No. 10,754,884) filed on Nov. 12, 2013, and U.S. patent application Ser. No. 14/325,094 filed on Jul. 7, 2014. In some implementations, the automated valuation models can comprise the one or more machine learning models described in relation to FIG. 2.

To obtain data used for training, the confidence model 262 can access a home data store 302 and/or a model data store 304 to obtain home data, actual values of homes, predicted values of homes, and/or model data. In some implementations, the home data store 302 and/or the model data store 304 can be remotely or locally connected to the confidence-boosted automated valuation system 300 via the network 230 described in relation to FIG. 2. In other implementations, the home data store 302 and/or the model data store 304 can be housed within the same computing device as that of the confidence-boosted automated valuation system 300. In various implementations, the databases 215 and 225 can include the home data store 302 and/or the model data store 304.

The home data and/or model data can be possible aspects or features of homes or the training and/or testing methodologies used that can affect the confidence in an automated valuation model's predicted value of a particular home. Such data can help the confidence model 262 better capture the uncertainty in the modeling pipeline of the automated valuation model. The home data can specifically include home data records describing features of homes (used herein as “home features”) of various types and in various different geographic regions or markets. Some of those homes may have been sold already (e.g., historical home transactions), some may currently be on the market (e.g., currently listed on the market), and some may not be for sale or on the market but can be valued. In some instances, each home data record can include a label for a particular home and the home features that describe the particular home. Examples of home features can include, but are not limited to, home facts, the number of bathrooms, the number of bedrooms, the date, the longitude/latitude, geographic location, school district, the square footage, the lot size, amenities, the existence of a pool (pool indicator variable), style, type, exterior construction, number of garage spaces, the ID, and/or the year built of the particular home. The home features can also include actual value of the particular home (e.g., sale price, listing price, market price, bidding price), the regional historical certainty of the particular home (e.g., regional historical error, standard deviation, and/or standard error in the price or market of homes in the region that the particular home is located in). The home features can further include how special the particular home is in its county or geographic location, such as, the land size or square footage difference from other homes, tax difference from neighboring or comparable homes, tax history (e.g., tax difference between different years or seasons, tax change after last sell of the home), age difference from neighboring or comparable homes, remodeling information, new construction information, and/or feature changes.

The model data can specifically include model data records associated with the training and/or testing of the automated valuation models. The model data can be pulled from the output, input, parameters, sub-models, processes, or pipelines of automated valuation model during training, testing and/or deployment thereof and then stored in the model data store 304. In some instances, each model data record can include a label for a particular home, an identifier of one or more automated valuation models that performed training and/or testing using the particular home (e.g., predicting a value for the particular home, fitting the model to the particular home), and the modelling information describing the training and/or testing of the one or more automated valuation models using the particular home. Examples of modelling information can include, but is not limited to sub-model agreement (e.g., comparison between different sub-model predicted values, the comparison of modeling methods between different sub-models, special evidence pertaining to certain sub-models compared to other sub-models) within each of the one or more automated valuation model (e.g., when each automated valuation model is an ensemble of models), how similar the predictive value of the particular home is to the actual values of comparable homes of the particular home (e.g., similarity scores between the particular home and each comparable home, the location of the particular home in relation to the geographical center of comparable homes), seasonal change of training data (e.g., how different from the majority of other homes in the model data is the particular home in terms of month, season, or rotation the particular home is sold, listed, or valued), missing data or bad data (e.g., imputed features during training or testing, missing data flags, missing public record of a certain feature for the particular home), historical stability of the one or more automated valuation models (e.g., is the algorithm stable or not), and/or the volatility in the predicted value of the particular home (e.g., last 6 month volatility in predicted value, cold start to training and/or testing of the automated valuation models may yield volatility in predicted values of homes, volatility estimated by new random seed).

In some implementations, the modelling information can also include the predicted error in the predicted value of the particular home generated by one or more automated valuation error models associated with the one or more automated valuation models (used herein as “AVM predicted error”). The AVM predicted error can represent an automated valuation error model's determination as to how confident or certain an automated valuation model is in its predicted value of the particular home. In various instances, the AVM predicted error can be an absolute percent error, percent error, average percent error, median percent error, dollar error, median dollar error, average dollar error, and/or absolute dollar error. The following applications, each of which is hereby incorporated by reference in its entirety, describe examples of automated valuation error models that can be employed to generate AVM predicted errors in the predicted values of homes: U.S. patent application Ser. No. 17/322,208 filed on May 17, 2021, U.S. patent application Ser. No. 16/951,900 filed on Nov. 18, 2020, U.S. patent application Ser. No. 11/971,758 (now U.S. Pat. No. 8,140,421) filed on Jan. 9, 2008, U.S. patent application Ser. No. 11/347,000 (now U.S. Pat. No. 8,676,680) filed on Feb. 3, 2006, U.S. patent application Ser. No. 11/347,024 (now U.S. Pat. No. 7,970,674) filed on Feb. 3, 2006, U.S. patent application Ser. No. 11/524,047 (now U.S. Patent Publication No. 2008/0077458) filed on Sep. 19, 2006, U.S. patent application Ser. No. 11/524,048 (now U.S. Pat. No. 8,515,839) filed on Sep. 19, 2006, U.S. patent application Ser. No. 11/971,758 (now U.S. Pat. No. 8,140,421) filed on Jan. 9, 2008, U.S. patent application Ser. No. 13/797,363 (now U.S. Pat. No. 9,361,583) filed on Mar. 12, 2013, U.S. patent application Ser. No. 13/828,680 filed on Mar. 14, 2013, U.S. patent application Ser. No. 14/078,076 (now U.S. Pat. No. 10,754,884) filed on Nov. 12, 2013, and U.S. patent application Ser. No. 14/325,094 filed on Jul. 7, 2014. In some implementations, the automated valuation error models can comprise the one or more machine learning models described in relation to FIG. 2.

Using the obtained home data, model data, actual values of homes, and/or predicted values of homes, the confidence-boosted automated valuation system 300 can train the confidence model 262 to produce confidence scores for the predicted values of homes. In some implementations, the confidence score can be interpreted or defined as the expected error in the predicted value of a home. Accordingly, a higher confidence score can mean a higher expected error and thus lesser confidence or certainty in the predicted value of the home. A lower confidence score can mean a lower expected error and thus greater confidence or certainty in the predicted value of the home. In other words, the confidence model 262 can predict what the expected error is in the predicted value of a home generated by the one or more automated valuation models. In some instances, the expected error determined by the confidence model 262 can be a refinement of the AVM predicted error. After training the confidence model 262, the confidence model 262 can generate confidence scores for predicted values of subject homes. A subject home can be a home of interest (e.g., a home not on the market but a buyer/seller would like to value before putting on the market, a home currently on the market but a buyer/seller would like q quote as to what the value should be) to generate a predicted value for (e.g., via the automated valuation models) and/or to determine a confidence or error for said predicted value.

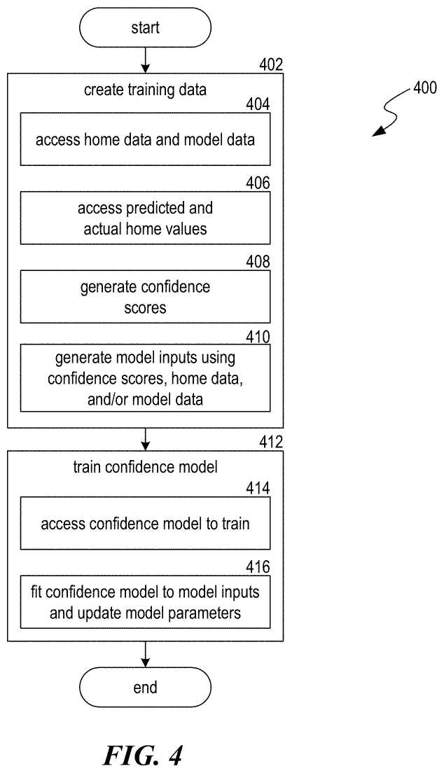

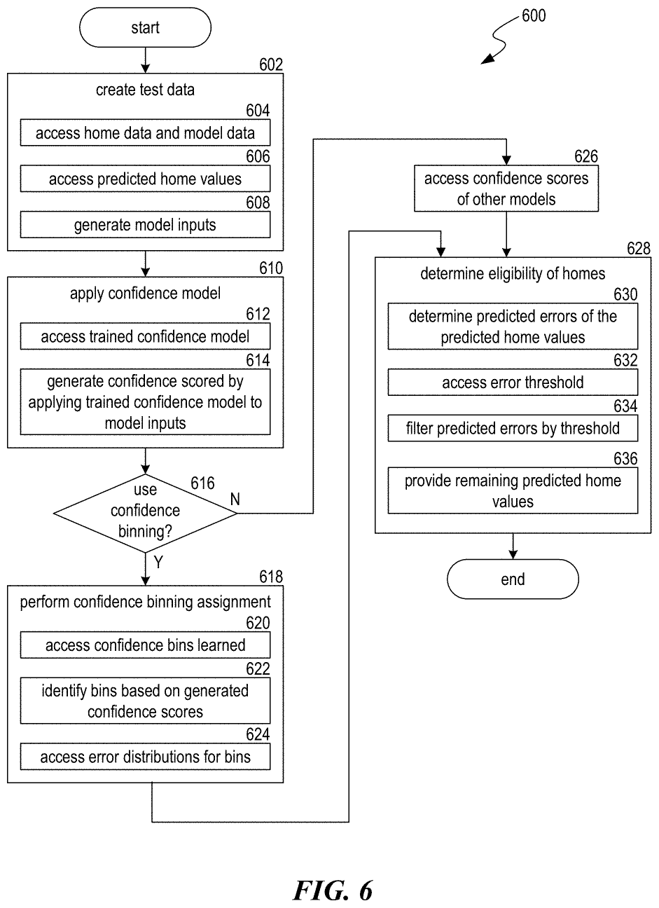

The confidence model 262 can store the generated confidence scores in a confidence data store 306. In some implementations, the confidence scores can be stored in the confidence data store 306 as confidence data records each including a label identifying the subject home, the predicted value of the subject home generated by the one or more automated valuation models, and the corresponding confidence score generated by the confidence model 262 for the predicted value. Similar to home data 302 and model data 304, the confidence data store 306 can also be remotely/locally connected to the confidence-boosted automated valuation system 300 via network 230, be housed within the same computing device as the confidence-boosted automated valuation system 300, and/or can be included in the databases 215 and 225. In various implementations, the confidence model 262 can provide the confidence scores to the confidence binning component 264 to be binned. More details regarding how confidence scores are generated are described below in relation to FIGS. 4 and 6.

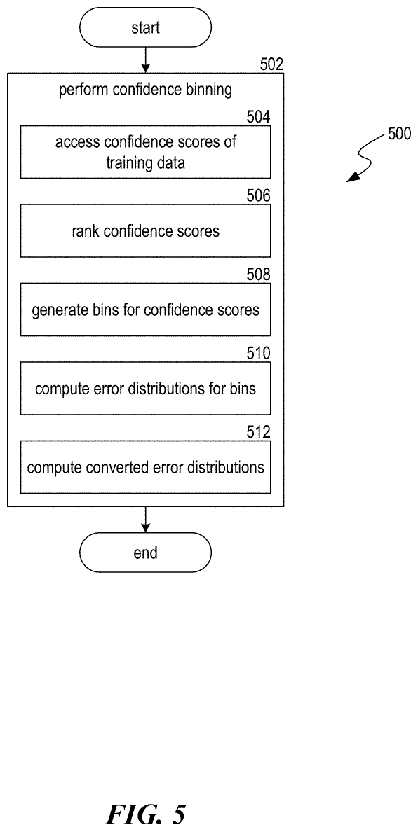

Since each confidence score also has an uncertainty (i.e., the confidence model 262 has uncertainty in producing confidence scores), the confidence binning component 264 can quantify this uncertainty before providing the confidence scores to downstream components of the confidence-boosted automated valuation system 300. The confidence binning component 264 can first access the confidence data store 306 to obtain confidence scores generated by the confidence model 262. Using the confidence scores, the confidence binning component 264 can generate a set of confidence bins that identify what confidence bins homes fall under according to their confidence score. When the uncertainty for the confidence score of a subject home is requested by the confidence-boosted automated valuation system 300, the confidence binning component 264 can identify a confidence bin for a subject home based on the confidence score of the subject home. The confidence binning component 264 can subsequently determine a predicted error in the predicted value of the subject home using the identified confidence bin. The predicted error can thus represent a refined confidence score after considering the uncertainty in the confidence model 262. The confidence binning component 264 can subsequently provide predicted errors to the home eligibility filter 268 for further processing. More details regarding confidence binning are described below in relation to FIGS. 5 and 6.

The home eligibility filter 268 can filter homes based on their confidence scores or predicted error. Since predicted values of homes generated with more confidence are more accurate valuations or closer to the actual value, the top confident homes can be those with lower confidence scores (i.e., lower expected error) produced by the confidence model 262 or lower predicted errors produced by the confidence binning component 264. The home eligibility filter 268 can filter homes to select those with greater confidence or certainty in predicted values, or in other words, those with lower confidence scores or predicted errors. The home eligibility filter 268 can obtain confidence scores of subject homes from the confidence model 262 or predicted errors of subject homes from the confidence binning component 264. Subsequently, the home eligibility filter 268 can filter the subject homes by whether the confidence scores or predicted errors exceed a predefined or empirically determined threshold and identify the remaining unfiltered subject homes (used herein as “confident homes” or “eligible homes”) as those with confident predicted values (used herein as “confident home values”). The home eligibility filter 268 can then provide or transmit the confident home values to a user computing device 308. In some instances, the user computing device 308 can be a device of a seller or buyer requesting a quote for a value of a subject home they would like to sell or buy, respectively. More details regarding filtering homes are described below in relation to FIG. 6.

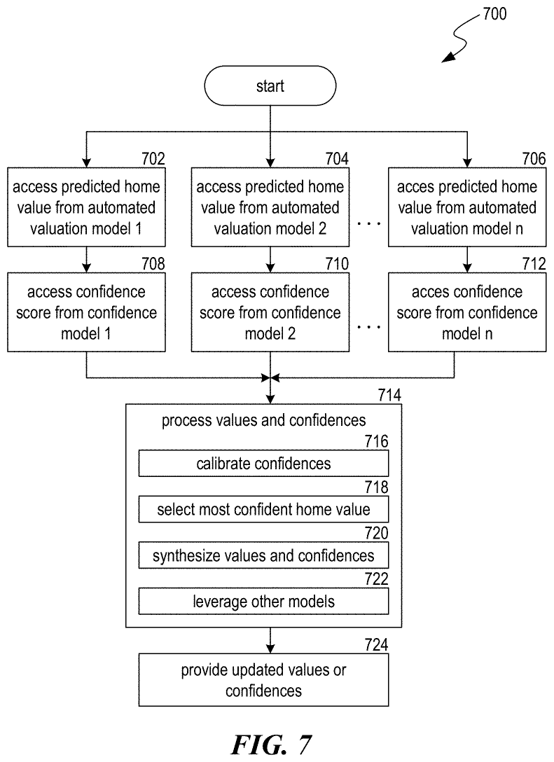

In some implementations, the confidence-boosted automated valuation system can also include the multi-model processor 266. The multi-model processor 266 can process the predicted values and/or confidence scores of homes generated by multiple different automated valuation modes and/or corresponding confidence models to generate more accurate predicted values and/or confidence scores for homes. The multi-model processor 266 can access the confident data store 306, the home data store 302, and/or the model data store 304 to obtain the confidence data, home data, and/or model data, respectively, for further processing. Different automated valuation models can predict values of homes with different degrees of certainty. By having access to the inputs, outputs, and parameters of multiple automated valuation models, the multi-model processor 266 can learn the underlying difference in certainty and predicted values produced by the multiple models to generate predicted values closer to actual values. In some implementations, the multi-model processor 266 can calibrate predicted values and/or confidence scores of homes to be more accurate. In various implementations, the multi-model processor 266 can synthesize the predicted values and/or confidence scores of homes generated by multiple models to determine more holistic predicted values and/or confidence that leverage the benefits of each of the multiple models. In further implementations, the multi-model processor 266 can determine instances when delivery of a predicted value of a home is not risky despite the predicted value having a confidence score that is filtered by the home eligibility filter 268. More details regarding the how processing is performed by the multi-model processor 266 are described below in relation to FIG. 7.

### Confidence Model

FIG. 4 is a flow diagram illustrating a process 400 of training a confidence model to produce confidence scores in accordance with some implementations of the present technology. At act 402, process 400 creates training data using the home data for a set of homes and/or the model data associated with the training or testing of automated valuation models fit or applied, respectively, to the set of homes. Process 400 can first identify the set of homes to be used in training a confidence model. For example, the set of homes identified can include a first particular home, second particular home, . . . and n-th particular home. In some implementations, the set of homes can be located in a similar geographic region/location, can share a similar real estate market, can be similar home types (e.g., apartment, townhouse, single-story home), can share a similar home feature, and/or can be valued by the same or similar automated valuation model. In some implementations, the set of homes can be randomly identified or selected from a large database of homes (e.g., historical home sales transactions located in databases 215 and 225 of FIG. 2). Process 400 can then identify the home data and/or model data corresponding to the set of homes.

At act 404, process 400 accesses the home data and/or the model data of the set of homes. In particular, process 400 can access a home data store and/or model data store to obtain the home data and/or the model data, respectively, for each particular home in the identified set of homes. In some implementations, the home data store and model data store can be the home data store 302 and the model data store 304, respectively, as described in relation to FIG. 2. In various implementations, process 400 can access the home data and/or model data to identify the home data records and/or the model data records that contain the label for each particular home in the set of homes. As an example, process 400 can obtain home data records, labeled with the first particular home, that describe features such as: 3 bedrooms, 1500 square feet, 2 bathrooms, 2 garage spaces, modern style, and Seattle zip code. As another example process 400 can obtain model data labeled with the first particular home and associated with the training and/or testing of automated valuation models fit or applied, respectively, to the first particular home. The model data obtained for the first particular home can include, e.g., a value indicating high sub-model agreement, a high volatility measure, a similarity score between the first particular home and comparable homes, and an imputed home feature for the school district of the first particular home. More details on other examples of home data and model data that can be obtained for the particular home are described in relation to the home data store 302.

At act 406, process 400 accesses predicted values and actual values of the set of homes. In some implementations, process 400 can access the home data store 302 to obtain the predicted value and the actual value for each particular home in the identified set of homes. As an example, process 400 can obtain a predicted value of $800,000 for the first particular home and an actual value of $810,000 (e.g., sale price, listing price, bid price, market price) for a comparable home of the first particular home. The predicted value of $800,000 can be generated by the one or more automated valuation models described in relation to FIG. 3 trained to estimate or predict the actual value of $810,000 for the first particular home. In various implementations, process 400 can access the home data store 302 to obtain the predicted value for each particular home in the identified set of homes and one or more actual values of one or more comparable homes for the particular home. As an example, process 400 can obtain a predicted value of $800,000 for the first particular home, an actual value of $810,000 (e.g., sale price, listing price, bid price, market price) for a first comparable home for the first particular home, and an actual of $790,00 for a second comparable home for the first particular home.

At act 408, process 400 generates confidence scores for the predicted values of the set of homes. In some implementations, process 400 can generate a confidence score for the obtained predicted value for each particular home in the identified set of homes using the obtained actual value and the predicted value of the particular home. Process 400 can generate the confidence score by computing the ground-truth error between the predicted value and actual value of the particular home. The ground-truth error can be the difference, absolute difference, percent difference, and/or absolute percent difference, and/or log-transform of any thereof between the predicted value and the actual value of the particular home. For example, process 400 can generate a confidence score of 10,000 for the first particular home by computing the absolute difference between the predicted value of $800,000 and actual value of $810,000.

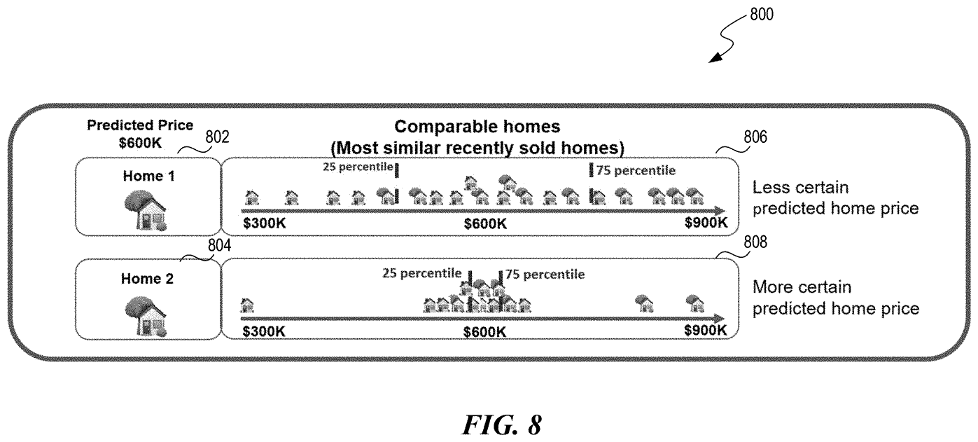

In some implementations, process 400 can generate a confidence score for the obtained predicted value for each particular home in the identified set of homes using the obtained actual values of the comparable homes for the particular home and the predicted value of the particular home. The actual values can include an actual value at a first quantile (e.g., an upper quartile or 75th percentile) of the set of actual values of the comparable homes and an actual value at a second quantile (e.g., a lower quartile or 25th percentile) of the set of actual values of the comparable homes. For example, assuming that the actual values of comparable homes are $780K, $790K, $800K, $810K, and $820K, the actual value at the upper quartile is $810K and the actual value at the lower quartile is $790K. A detailed visualization of the upper and lower quartiles of the comparable homes is described below in relation to FIG. 8. In some implementations, process 400 can generate the confidence score by applying the following computation or formula:

$$\frac{actual {value}_{first quantile} - actual {value}_{second quantile}}{predicted value of home}$$

In other words, process 400 can first compute the difference between the actual value at the first quantile of the comparable homes and the actual value at the second quantile of the comparable homes. Process 400 can then compute the confidence score as said difference divided by the predicted value of the particular home. For example, process 400 can compute the confidence score to be 0.025 by computing the difference between the actual value at the upper quartile of $810,000 and the actual value at the lower quartile $790,000 to be $20,000, and then dividing this difference of $20,000 by the predicted value of the first particular home of $800,000. In some implementations, process 400 can store the generated confidence scores for the identified set of homes in the confidence data store 306.

By utilizing how far apart the first and second quantile actual values of the comparable homes are, process 400 can focus on the middle half of the distribution of actual values of the comparable homes of the particular home. If the difference between the first and second quantile actual values is great (i.e., wider spread in distribution of actual values of comparable homes), then the comparable homes can be more different in their actual value, which also means that the particular home can have a wider range of possible actual values it could have. Accordingly, process 400 can determine from this greater difference that the automated valuation models are probably less certain or confident in their predicted valuation of the particular home. If the difference between the first and second quantile actual values is small (i.e., tighter spread in distribution of actual values of comparable homes), then the comparable homes can be more similar in their actual value, which also means that the particular home can have a smaller range of possible actual values. Accordingly, process 400 can determine from this lesser difference that the automated valuation models are probably more certain or confident in their predicted valuation of the particular home.

At act 410, process 400 generates model inputs, for a confidence model to be trained at act 412, using the generated confidence scores, the accessed/obtained home data, and/or the accessed/obtained model data. In particular, process 400 can generate/create a model input using the generated confidence score, the home data, and/or the model data for each particular home in the identified set of homes. In some implementations, process 400 can first generate/create a feature vector (e.g., actual data, encoding, embedding) to represent each particular home's home data, model data, and/or predicted value. Process 400 can then generate the model input for each particular home as a tuple of the particular home's feature vector and the ground-truth confidence score generated for the predicted value of the particular home (e.g., tuples of the form {feature vector, confidence score}). For example, the model input for the first particular home can be: {[first particular home's feature vector], 0.025}.

At act 412, process 400 trains the confidence model using the model inputs generated at act 410. The ground-truth confidence scores of the model inputs can be the error or uncertainty that the confidence model learns to fit or produce based on the inputted feature vectors of the model inputs. Accordingly, process 400 can learn to produce confidence scores by identifying patterns or trends in the home data and/or the model data in relation the ground-truth confidence scores. At act 414, process 400 can access/obtain the confidence model to train. In some implementations, the obtained confidence model can be the confidence model 262. At act 416, process 400 fits the confidence model to the generated model inputs and updates model parameters as the model is fitted. The model parameters can include, e.g., weights, biases, constants, and/or hyperparameters of the confidence model. In some implementations, process can train and fit the confidence model using any of the methodologies used to train or test of the one or more machine learning models described in relation to FIG. 2. In various implementations, process 400 can provide the confidence model, trained to produce confidence scores, to process 600 at act 612 of FIG. 6.

### Confidence Binning

FIG. 5 is a flow diagram illustrating a process 500 of confidence binning in accordance with some implementations of the present technology. At act 502, process 500 performs confidence binning of homes. In some implementations, process 500 can be triggered to perform confidence binning of the identified set of homes in process 400 of FIG. 4 upon completion of process 400. Since the confidence model of process 400 and the confidence scores it is trained to produce still have uncertainty, process 500 can perform confidence binning to quantify this uncertainty for subsequent downstream systems/models that use the confidence scores (e.g., the conversion function at act 512 of process 500).

At act 504, process 500 accesses the confidence scores of training data used. In some implementations, process 500 can access the confidence data store 306 of FIG. 3 to obtain the confidence scores of the identified set of homes used in the training data created in process 400. At act 506, process 500 ranks the confidence scores of the identified set of homes. In particular, process 500 can rank the confidence scores in order from smallest to largest. For example, assuming that the confidence scores for the first through sixth particular homes are 0.025, 0.018, 0.008, 0.01, 0.022, and 0.009, process 500 can rank the confidence scores in the order of 0.008, 0.009, 0.01, 0.018, 0.022, and 0.025. Accordingly, process 500 can rank the corresponding particular homes in the order of the third, sixth, fourth, second, fifth, and first particular home.

At act 508, process 500 generates confidence bins for the confidence scores. Process 500 can partition the identified set of homes into confidence bins each containing a subset of the set of homes, where each subset contains particular homes sharing similar confidence scores. In other words, for any confidence score of a particular home that falls within the upper and lower bounds, process 400 can place the particular home in that confidence bin.

A confidence bin can comprise bin threshold values that define the bounds (i.e., an upper and lower bounds) or size of the confidence bin. The size or bounds of the confidence bins can be predefined (e.g., always bin sizes of 0.01 or upper and lower bounds within 0.01 of one-another), can be fine-tuned based on the granularities of the confidence scores (e.g., bin sizes of 0.05 when the confidence scores are mostly within 0.05 of one another or upper and lower bounds within 0.05 of one-another), or can be empirically determined or fine-tuned. The size, bounds, or bin threshold values of the confidence bins can also be determined based on a number of factors including the market/location of the set of homes, the current time, the types of properties of the set of homes (e.g., real estate, commercial, townhouse, condo, apartment, single-family home, multi-family home, co-op etc.), and/or the home features of the set of homes. For example, when the market or location includes homes that have actual values relatively close to one-another, the confidence bins can have much tighter bounds, smaller sizes, or closer bin threshold values. As another example, when the types of properties of the set of homes are very different from one-another, the confidence bins can have much wider bounds (i.e., upper and lower bounds defined far apart), large sizes, or bin threshold values further from one-another. The upper bound and/or lower bound of the confidence bins can be inclusive or non-inclusive (e.g., [lower bound, upper bound), (lower bound, upper bound], in which the parentheses can indicate exclusive and the brackets can indicate inclusive) of a confidence score that lies on the bound. The smaller the bin size, the more confident process 500 can be regarding the confidence score for the particular home. In some implementations, the confidence bins can overlap or be discrete.

In some implementations, the bin threshold values or sizes of the confidence bins can be determined ad hoc by examining each confidence bin's training data size (e.g., how many homes from the training data fall within the confidence bin). In particular, the bin threshold values or sizes of the confidence bins can be determined by identifying bin sizes that result in confidence bins having good sample sizes (e.g., at least a threshold number of homes within the confidence bin) and/or yielding realizable distributions (e.g., bin threshold values or sizes that allows process 500 to generate, at act 510, error distributions that are realizable). The bin sizes can be configured based on analysis of historical data or adjusted manually after analysis on future data. Based on the analysis, process 500 can configure or adjust the bin sizes by: (1) reducing the size or tightening the bounds and bin threshold values, or (2) increasing the size or widening the bounds and bin threshold values.

Continuing with the above example, when the bin sizes are predefined to be 0.01, process 500 can partition the first through sixth particular homes into the following confidence bins:

Confidence Bin 1 [0, 0.01): third and sixth particular homes

Confidence Bin 2 [0.01, 0.02): fourth and second particular homes

Confidence Bin 3 [0.02, 0.03): fifth and first particular homes

At act 510, process 500 generates/computes error distributions for the generated confidence bins. In particular, process 500 can, for each confidence bin, compute a distribution for the confidence scores of the subset of homes in the confidence bin. In some implementations, the distribution can be a frequency distribution or probability distribution, and the confidence score, which is an error value, can be the random variable described by the distribution. The distribution can also be known as an error distribution for the confidence bin since the confidence scores represent expected errors in the predicted value of the particular homes. As an example, for each of the first, second, and third confidence bins, process 500 can compute the error distribution for the confidence scores in that confidence bin. The error distribution can represent a distribution of how confident or certain the predicted values of the subset of homes in the confidence bin are. The error distribution can also capture how certain the confidence scores of the subject of homes in each bin are. A narrower error distribution can represent less variance or spread in the error of the predicted value of particular homes that fall within the confidence bin associated with the error distribution. A wider error distribution can represent more variance or spread in the error of the predicted value of particular homes that fall within the associated confidence bin. In some implementations, process 500 can store the error distributions as tables including a column describing the error at each percentile.

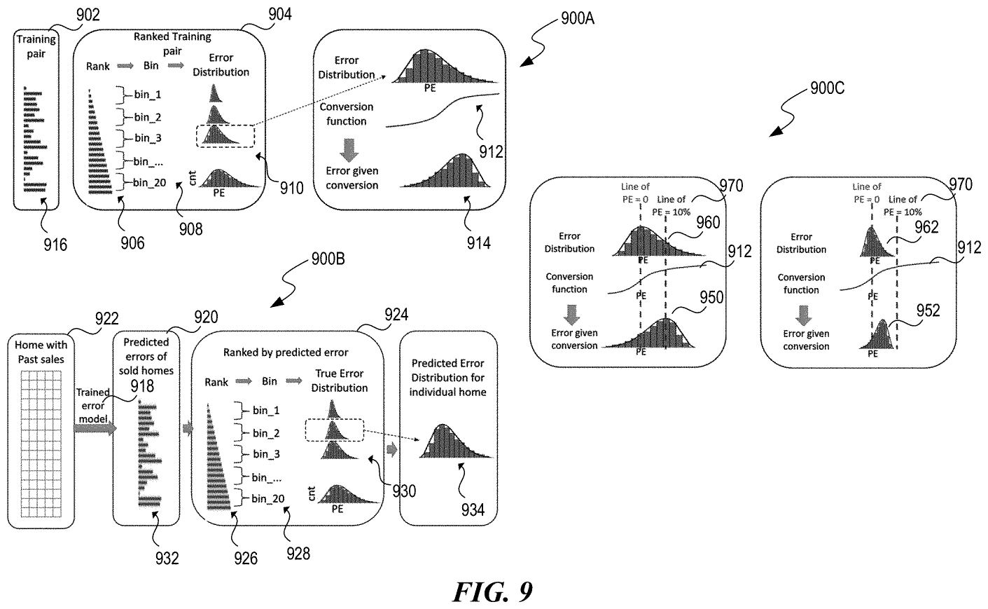

At act 512, process 500 computes converted error distributions of the confidence bins. In particular, for each confidence bin, process 500 can apply Bayes' rule to compute the converted error distribution for each confidence bin, i.e., the error distribution conditional on conversion for each confidence bin. In some implementations, process 500 can compute converted error distributions by using a conversion function (e.g., applying the conversion function to the error distributions of the confidence bins). The conversion function can be, for example, a piecewise linear function or logistic function based on historical empirical conversion data. The historical empirical conversion data can include expected errors, from historical errors of home sale transactions (e.g., historical error distributions computed for confidence scores, historical errors from automated valuation models or error models), that are labeled with desired/target converted errors (e.g., target conversion probabilities or percent errors). The function can adjust a pricing error by a conversion rate of a home sale transaction to yield a desired converted pricing error. For example, the conversion function can specify a conversion probability of:

$$conversion\_probability ( error ) = \frac{1}{1 + {e}^{- ( a + b \cdot error )}}$$

where a and b are constants learned from the historical data or errors to yield a desired conversion probability. More details on the conversion function are described below in relation to FIG. 9.

In some implementations, process 500 evaluates the generated confidence bins. In particular, process 500 can evaluate the performance of the confidence bins, generated at act 508, when applied to confidence scores of predicted values of homes in a test dataset (e.g., validation data, time holdout validation data). Process 500 can first determine the eligible homes (also known as “confident homes”) or number of eligible homes in the validation or test dataset and their corresponding confident home values via act 628 in process 600 of FIG. 6. More details regarding determining eligible homes in the test or validation data are described below in relation to process 600. Process 500 evaluates or determines whether the number of eligible homes in the validation or test dataset that have a predicted value within a predefined range of the actual value of the eligible home exceeds a predefined threshold. For example, process 500 can determine whether at least ⅓ of the eligible homes in the validation set have a predicted value that is within a range of $5,000 of their actual value. Upon determining the number of eligible homes does exceed the predefined threshold, process 500 can provide the confidence bins and bin threshold values thereof to act 620 in process 600. Subsequently, process 500 ends. Upon determining the number of eligible homes does not exceed the predefined threshold, process 500 can adjust the confidence bins. More specifically, process 500 can adjust the confidence bins by adjusting the size, bin threshold values, or bounds of the confidence bins. In some instances, process 500 can adjust the confidence bins by reducing the size or tightening the bounds and bin threshold values. In various instances, process 500 can adjust the confidence bins by increasing the size or widening the bounds and bin threshold values. Process 500 can adjust the confidence bins based on any of the factors described in relation to act 508. In some implementations, the sizes, bounds, or bin threshold values can be hyperparameters of the confidence binning component. Process 500 can fine-tune the hypermeters until the confidence bins yield a performance that exceeds the predefined threshold after being re-evaluated.

### Determining Home Eligibility

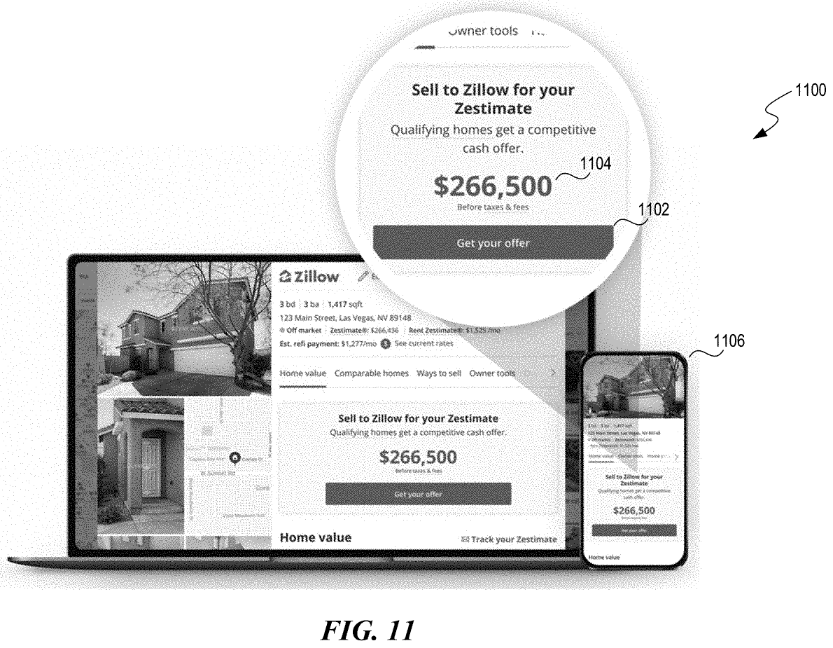

FIG. 6 is a flow diagram illustrating a process 600 of determining homes with confident homes values in accordance with some implementations of the present technology. In some implementations, process 600 can be triggered upon receiving requests, transmitted from one or more user devices, for offers for or valuations of one or more subject homes from the confidence-boosted automated valuation system (e.g., seller clicks on a GUI button of the home display page of FIG. 11 to get an offer for their home). In some implementations, process 600 can be triggered at any instance when there are subject homes to determine a confidence for or when an automated valuation model has completed valuation of one or more subject homes. In various implementations, process 600 can be triggered upon completion of process 400 of FIG. 4 and/or process 500 of FIG. 5.

At act 602, process 600 creates test data using the home data for the one or more subject homes and/or the model data associated with the testing of automated valuation models applied to the one or more subject homes. Process 600 can first identify the one or more subject homes to create a batch of test data from upon the triggering of process 600. For example, the one or more subject homes identified can include a first subject home, a second subject home, . . . and an n-th subject home. In some implementations, the one or more subject homes can be located in a similar geographic region/location, can share a similar real estate market, can be similar home types (e.g., apartment, townhouse, single-story home), can share a similar home feature, and/or can be valued by the same or similar automated valuation model. In some implementations, the one or more subject homes can be randomly identified or selected from a large database of homes (e.g., historical home sales transactions located in databases 215 and 225 of FIG. 2). Process 600 can then identify the home data and/or model data corresponding to the one or more subject homes.

At act 604, process 600 accesses home data and/or model data of the one or more subject homes. In particular, process 600 can access a home data store and/or model data store to obtain the home data and/or the model data respectively, for each subject home in the identified one or more subject home. In some implementations, the home data store and model data store can be the home data store 302 and the model data store 304, respectively, as described in relation to FIG. 3. More details on the types of home data and/or model data that process 600 can access for a home are described in relation to act 404 of process 400.

At act 606, process 600 accesses predicted values of the one or more subject homes. In some implementations, process 600 can access the home data store 302 to obtain the predicted value for each subject home in the identified one or more subject homes. As an example, process 600 can obtain a predicted value of $1 million for the first subject home and a predicted value of $1.1 million for a second subject home. The predicted values of the one or more subject homes can be generated by the one or more automated valuation models described in relation to FIG. 3.

At act 608, process 600 generates model inputs, for a confidence model to be applied at act 610, using the accessed/obtained predicted values, the home data, and/or the model data of the one or more subject homes. In particular, process 600 can generate/create model input using the predicted value, the home data, and/or the model data for each subject home in the identified one or more subject homes. In some implementations, process 600 can first generate/create a feature vector (e.g., actual data, encoding, embedding) to represent each subject home's home data (i.e., subject home data), model data and/or predicted value. Process 600 can then generate the model input for each subject home as a tuple of the subject home's feature vector (e.g., tuples of the form {feature vector}). For example, the model input for the first subject home can be: {[first particular home's feature vector]}. In some implementations, prior to generating the model inputs, process 600 can clean the or smooth the predicted values, home data, and/or model data of the one or more subject homes.

At act 610, process 600 applies a confidence model to the generated model inputs. At act 612, process 600 can first access/obtain a confidence model trained to produce confidence scores. In some implementations, process 600 can obtain the confidence model trained to produce confidence scores from act 412 of FIG. 4. At act 614, process 600 generates confidence scores by applying the obtained confidence model, trained to produce confidence scores, to the obtained predicted values, home data, and/or model data of the one or more subject homes. More specifically, process 600 can apply the trained confidence model to the generated model inputs. The confidence model can input the model inputs and generate/output a confidence score for each of the one or more subject homes associated with the model inputs.

At act 616, process 600 determines whether to use confidence binning. In some implementations, process 600 can by default be set to either use or not use confidence binning. In various implementations, process 600 can determine to perform confidence binning when process 500 has been completed. In further implementations, process 600 can determine to not perform confidence binning when process 500 has not been completed or an indicator to access the confidence scores of other confidence models is received. Upon determining to use confidence binning, process 600 proceeds to act 618. Upon determining to not use confidence binning, process 600 proceeds to act 626.

At act 618, process 600 performs confidence binning assignment of each of the one or more subject homes. In particular, process 600 can bin the confidence of each subject home of the identified one or more subject homes. At act 620, process 600 accesses the learned error distributions of the confidence bins. More specifically, process 600 can obtain the learned error distributions of the confidence bins generated at act 502 of FIG. 5.

At act 622, process 600 identifies confidence bins based on the confidence scores generated for each of the one or more subject homes. In some implementations, process 600 can, for each subject home, identify an obtained/accessed confidence bin that the subject home falls in using the confidence score. In particular, process 600 can determine which confidence bin has bin threshold values or bounds that the confidence score for the subject home falls within. Process 600 can identify the determined confidence bin as the one the subject home falls in and assign the bin to the subject home. In various implementations, process 600 can generate new confidence bins for the one or more subject homes, rather than using the learned confidence bins, using the approaches described in relation to act 508 of process 500. Process 600 can subsequently identify the newly generated confidence bin that each subject home falls in.

At act 624, process 600 accesses the error distributions for the confidence bins identified for the one or more subject homes. In some implementations, process 600 can, for each confidence bin identified for each subject home, obtain/access the error distribution or converted error distribution for that confidence bin generated/computed at act 510 or 512, respectively of process 500. In various implementations, when new confidence bins are generated for the one or more subject homes, process 600 can generate/compute an error distribution for each of the newly generated confidence bins. Process 600 can generate/compute the error distributions using the approaches described in relation to act 510 and 512 of process 500.

At act 626, process 600 accesses confidence scores of the one or more subject homes generated or processed by other models. In some implementations, the other models can be those described more in detail below in relation to process 700 of FIG. 7. The accessed confidence scores can be those that are calibrated, synthesized, expedited/non-expedited, filtered, or adjusted from the confidence scores generated at act 614, according to any of the approaches described in relation to process 700. In some implementations, the accessed confidence scores can just be those generated at act 614. In various implementations, the accessed confidence scores can include the AVM predicted errors described in relation to FIG. 3.

At act 628, process 600 determines the eligibility of the one or more subject homes. More specifically, process 600 can determine whether each subject home of the one or more subject homes is eligible to be offered as a confident home. At act 630, process 600 determines the predicted errors of the predicted values of the one or more subject homes. Process 600 can determine a predicted error in the predicted value of each subject home in the one or more subject homes using the error distribution or converted error distribution of the confidence bin identified for the subject home. In particular, process 600 can first, for each error distribution or converted error distribution, determine the mean, weighted mean, median, or weighted median of the distribution. When the confidence model is trained on confidence scores generated by computing the difference between the predicted value and actual value of a home (e.g., one of the approaches described in relation to act 408 of process 400), process 600 can determine the predicted error in the predicted value of a subject home to be a synthetization (e.g., mean, weighted mean, median, or weighted median) of the computed error distribution or converted error distribution associated with the subject home. When the confidence model is trained on confidence scores generated from actual value quantiles of comparable homes (e.g., one of the approaches described in relation to act 408 of process 400), process 400 can determine the predicted error by further multiplying the synthetization by the predicted value of the subject home associated with the error distribution. By performing the multiplication, process 400 can dollarize the mean, weighted mean, median, or weighted median as the predicted error.

At act 632, process 600 accesses/obtains an error threshold. In some implementations, the error threshold can be a predefined error threshold that the predicted error in the predicted value of a subject home must not exceed for the predicted value to be considered a confident home value and the subject home to be considered a confident home. For example, the error threshold can be $13,000, meaning that a predicted error may not exceed $13,000 for the associated predicted value to be considered a confident home value. In various implementations, the error threshold can be adjusted such that only a top percentage of fraction (e.g., 25%, ⅓) of the subject homes get selected as confident homes or are deemed to have confident home values. Selecting only the top subject homes can result in less adverse selection since such subject homes likely fall in confidence bins with narrower error distributions, and consequently less spread or variance in error. The top subject homes ranked by predicted error can also have a much smaller median/average absolute percent error, standard deviation, or variance than the other subject homes or all of the one or more subject homes as a whole. By using an error threshold, process 600 can filter out subject homes with extreme predicted values and reduce the number of outlier predicted values that get offered to sellers/buyers. Such filtering can result in process 600 providing only the most accurate predicted values as confident home values to end users or other downstream systems/models.

At act 634, process 600 filters the predicted error in the predicted values of the one or more subject homes by the error threshold. Process 600 can filter out predicted errors that exceed the error threshold. Process 600 can determine the predicted errors that do not exceed the error threshold and identify these predicted errors as one or more remaining/unfiltered predicted errors. The predicted values corresponding to the predicted errors can be identified as one or more remaining predicted values of subject homes.

At act 636, process 600 provides the one or more remaining predicted values of subject homes as confident home values. Process 600 can provide the remaining predicted values upon determining at act 634 that the corresponding predicted error does not exceed the error threshold. The confident home values can be those values of subject homes eligible to be offered to a seller/buyer. The subject homes corresponding to the remaining predicted errors can thus be confident homes. In some implementations, process 600 can provide the one or more remaining predicted values by transmitting the confident homes values to a user device and causing generation of, on a user-interface of the user device, a graphical representation of the confident home values (e.g., the graphical representation or home display page described below in relation to FIG. 11). The user device can correspond to that of a seller/buyer.

In some implementations, process 600 can perform additional filtering before providing the remaining predicted values. Process 600 can filter out predicted values of subject homes with confidence scores that exceed a confidence score threshold, predicted values of subject homes generated by automated valuation models deemed as ineligible (e.g., due to lack of stability in the model), predicted values of subject homes that are already being offered to users (e.g., already being presented on a home display page or GUI to a seller/buyer), and/or predicted values of subject homes with certain home features deemed as ineligible (e.g., home facts that are ineligible such as too many number of bathrooms). In various implementations, process 600 can include an error model quality control component that performs said additional filtering.

### Multi-Model Processing

FIG. 7 is a flow diagram illustrating a process 700 of processing predicted values and/or confidence scores of homes generated by multiple models in accordance with some implementations of the present technology. At act 702, process 700 accesses a predicted home value from a first automated valuation model or automated valuation model 1 (used herein as “first predicted value”). In particular, process 700 can access the home data store 304 described in relation to FIG. 3 to obtain the first predicted value of a first home. The first automated valuation model can generate the first predicted value, which can be stored in the home data store 304. At act 704, process 700 accesses a predicted home value from a second automated valuation model or automated valuation model 2 (used herein as “second predicted value”). In particular, process 700 can access the home data store 304 to obtain the second predicted value of a second home. The second automated valuation model can generate the second predicted value, which can be stored in the home data store 304. At act 706, process 700 accesses a predicted home value from an n-th automated valuation model or automated valuation model n (used herein as “n-th predicted value”), where n can be any integer greater than 2. In particular, process 700 can access the home data store 304 to obtain the n-th predicted value of a n-th home. The n-th automated valuation model can generate the n-th predicted value, which can be stored in the home data store 304. Although not shown, the ellipses in FIG. 7 indicate that process 700 can access up to “n” predicted values from “n” automated valuation models. In some implementations, the first, second, or n-th home can be a subject home described in relation to process 600 of FIG. 6.

At act 708, process 700 access a confidence score from a first confidence model or confidence model 1 (used herein as “first confidence score”). In particular, process 700 can access the home data store 304 to obtain the first confidence score. The first confidence model can generate the first confidence score for the first predicted value and store the generated first confidence score in the confidence data store 306. At act 710, process 700 access a confidence score from a second confidence model or confidence model 2 (used herein as “second confidence score”). In particular, process 700 can access the home data store 304 to obtain the second confidence score. The second confidence model can generate the second confidence score for the second predicted value and store the generated second confidence score in the confidence data store 306. At act 712, process 700 access a confidence score from an n-th confidence model or confidence model n (used herein as “n-th confidence score”). In particular, process 700 can access the home data store 304 to obtain the n-th confidence score. The n-th confidence model can generate the n-th confidence score for the n-th predicted value and store the generated n-th confidence score in the confidence data store 306. Although not shown, the ellipses in FIG. 7 indicate that process 700 can access up to “n” confidence scores from “n” confidence models. In some implementations, the first, second, or n-th confidence model can be the confidence model trained to produce reply scores described in relation to process 500 of FIG. 5. In various implementations, the first, second, and/or n-th confidence models can generate confidence scores for the predicted values generated by the first, second, and n-th automated valuation models, respectively. In other words, the first, second, and n-th confidence models can be associated with first, second, and n-th automated valuation models, respectively. In various implementations, process 700 can perform acts 702-712 in parallel or sequentially in any order.

At act 714, process 700 processes one or more of the first through n-th predicted values and/or one or more of the first through n-th confidence scores to produce one or more updated confidence scores and/or predicted values. For simplicity of discussion, process 700 can process the first predicted value, the first confidence score, the second predicted value, the second confidence score, the n-th predicted value, and/or the n-th confidence score to produce the one or more updated confidence scores and/or predicted values. In some implementations, processing the predicted values and/or confidence scores can include process 700 performing one or more of acts 716-722 in any order.

### Core Calibration Model

When multiple automated valuation models are leveraged (e.g., the first, second, and n-th automated valuation models), it can be unclear as to which automated valuation model's predicted values should be selected. Furthermore, the confidence score usually is algorithmic specific (e.g., pertains specifically to each of the individual first, second, and n-th confidence models) and each confidence model (e.g., the first, second, and n-th models) may have different patterns of distortion due to each confidence model's intrinsic limitations and training data imbalance. As a result, the confidence scores generated by the confidence models (e.g., the first, second, and n-th confidence scores) may not be directly comparable and a calibration step may be needed. To address these challenges, process 700 can use a core calibration model. The core calibration model can be trained on out of sample data and can calibrate the raw predictions of confidence scores from multiple models (e.g., the first, second, and n-th models) to a similar or same standard. The core calibration model can define a common interface or calibration standard and generate calibrated confidence scores. Process 700 can then synthesize the calibrated confidence scores and integrate them by intuitive rules. With a well-defined standard, each confidence model and calibration model can run in the automated valuation model's architecture since they are closely coupled. Moreover, with well calibrated confidence scores, the confidence-boosted automated valuation system can use the confidence scores to compare the various automated valuation models or confidence models under a common standard. More details on how process 700 uses the core calibration model are described as follows.

At act 716, process 700 calibrates the first, second, and n-th confidence scores. More specifically, process 700 can generate a calibrated confidence score for each of the confidence scores by applying a calibration model to each confidence score. For example, process 500 can generate a calibrated first confidence score by applying a first calibration model, trained to calibrate the confidence scores, to the first confidence score. Process 500 can then generate a calibrated second confidence score by applying a second calibration model, trained to calibrate the confidence scores with a similar calibration standard as that of the first calibration model, to the second confidence score. Process 500 can further generate a calibrated n-th confidence score by applying an n-th calibration model, trained to calibrate the confidence scores with a similar calibration standard as that of the first and/or second calibration models, to the n-th confidence score. Process 500 can subsequently provide the calibrated confidence scores as one or more updated confidence scores at act 724.

Since the distribution of the distortion between different confidence models or automated valuation models can be irregular, the core calibration model (e.g., the first, second, and/or n-th calibration model) can be an isotonic regression. The isotonic regression can keep the certainty/error ranking of homes and empirically calibrate to the true error on unseen data, despite the calibration/adjustment needed for each confidence model being unknown and the pattern being different for different confidence models. In some implementations, the first, second, and n-th calibration models can be trained on similar training data as that of the first, second, and n-th confidence models or valuation models.

### Confidence Selector Model

A general confidence selector model can take confidence scores (e.g., the first, second, and n-th confidence scores), the theoretical or empirical distribution of error predictions for the confidence scores, and also key home features as input to learn how to select the most confident home value. In some implementations, the confidence selector model can be classifier model or any of the machine learning models described in relation to FIG. 2. More details on how process 700 uses the confidence selector model are described as follows.

At act 718, process 700 selects the most confident home value. Process 700 can select a most confident predicted value from the first, second, and n-th predicted values using the confidence selector model. In particular, process 700 can first generate model input for the confidence selector model. The model input can be a feature vector representing (1) the first, second, and n-th confidence scores, (2) home data and/or model data associated with the first, second, and n-th confidence scores, and (3) error distributions associated with the first, second, and n-th confidence scores. Process 700 can apply the confidence selector model, trained to select most confident predicted values, to the generated model input. The confidence selector model can them output the most confident predicted value. In some implementations, the n-th confidence score can be generated from an ensemble of the first and second confidence models. In various implementations, the confidence model can select a most confident predicted value after classifying the most accurate predicted value amongst the first, second, and n-th predicted values and triaging based on generated probabilities for each of the predicted values from the first, second, and n-th automated valuation models. Process 700 can provide the most confident predicted value as an updated predicted value of a most confident home at act 724.

### General Combiner

A general combiner can blend or synthesize models. In some implementations, a triage can handle the discarding of uncertain predicted values of homes. More details on how process 700 uses the general combiner are described as follows.

At act 720, process 700 can synthesize or combine the first, second, and n-th predicted values. Process 700 can first identify remaining predicted values by filtering, based on the first, second, and n-th confidence scores, at least one predicted value out of the first, second, and n-th predicted values. In some implementations, a triage model can perform filtering by discarding the predicted values among the first, second, and n-th predicted values that are uncertain. The triage model can be any of the machine learning models described in relation to FIG. 2 or FIG. 3 that is trained to identify uncertain predicted values. After filtering the predicted values, process 700 can determine an updated predicted value by synthesizing the remaining predicted values. The synthetization can be a mean, median, weighted mean, weighted median, or other measure of central tendency of the remaining predicted values. Process 700 can provide the updated predicted value at act 714. This updated predicted value can be a combined predicted value estimating the actual value of the first, second, and n-th home in aggregate.

Explainable and not-Easily-Explainable Models

In some implementations, process 700 can leverage a not-easily-explainable or not-easily-interpretable automated valuation model for an explainable or interpretable automated valuation model to deliver more explainable automated valuation models as confident valuation models. At act 722, process 700 can leverage a not-easily-explainable automated valuation model for an explainable automated valuation model. For example, the first valuation model can be a not-easily-explainable model, while the second valuation model can be an explainable model. Process 700 can determine whether to provide the second valuation model as a confident valuation model based on the first confidence score and the second confidence score. In particular, process 700 can determine to provide the second valuation model as a confident valuation model when the first predicted value is confident, the second confidence score is not confident, and the second predicted value is within a predefined range of the first predicted value. Process 600 can also instead determine not to provide the second valuation model as a confident valuation model when the first predicted value is confident, the second confidence score is not confident, and the second predicted value is not within a predefined range of the first predicted value.

### Conceptual Diagrams

FIG. 8 is a conceptual diagram illustrating an example 800 of interquartile ranges of actual values of comparable homes in accordance with some implementations of the present technology. Example 800 includes a first home 802 and a comparable home 804 each with a predicted value of $500K generated by one or more automated valuation models. Each of the homes includes a set of comparable homes with prices ranging from $300K to $900K. The first home 802 includes comparable homes with a range of actual values 806. The second home 804 includes comparable homes with a range of actual values 808. Example 800 shows that the range of actual values 806 has a lower quartile (25th percentile) of around $500K and an upper quartile (75th percentile) of around $750K. Example 800 further shows that the range of actual values 808 has a lower quartile (25th percentile) of around $590K and an upper quartile (75th percentile) of around $610K. Accordingly, the first home 802 has comparable homes with a larger interquartile range of actual values, while the second home 804 has comparable homes with a smaller interquartile range of actual values. In other words, the middle 50% of comparable homes of the first home 802 has a greater spread of actual values, while the middle 50% of comparable homes of the second home 804 has a smaller spread of actual values. The greater spread of comparable homes for the first home 802 can indicate that there are more possible values that the actual value for the first home 802 can be. Accordingly, the first home 802 has a less certain/confident predicted value or home price of $600K. The smaller spread of comparable homes for the second home 804 can indicate that there are fewer possible values that the actual value for the second home 804 can be. Accordingly, the second home 804 has a more certain/confident predicted value or home price of $600K. More details on interquartile ranges of actual values of comparable homes are described above in relation to act 402 of process 400 in FIG. 4.

FIG. 9 is a conceptual diagram illustrating examples 900A, 900B, and 900C of confidence bins and error distributions of confidence scores in accordance with some implementations of the present technology. Example 900A shows a graphical representation of the confidence-boosted automated valuation system performing confidence binning on training data as described more in detail above, for example, in relation to process 500 of FIG. 5. Example 900A includes training data 902 with confidence scores 916. Example 900A shows the confidence-boosted automated valuation system training or learning confidence bins (element 904) using the training data 902. The confidence-boosted automated valuation system can first rank the confidence scores 916 of the training data 902 into the ranked confidence scores 906. The confidence-boosted automated valuation system can generate confidence bins 908 for the ranked confidence scores (e.g., bin_1, bin_2, bin_3, . . . , bin_20). The confidence-boosted automated valuation system can then compute/generate error distributions 910 for the confidence bins 908. The x-axis of the error distributions 910 can represent the empirical true percent error (“PE”) or dollar error, while the y-axis of the error distribution 910 can represent the count (“cnt”) or number of particular homes with the corresponding empirical error. After generating the error distributions 910, the confidence-boosted automated valuation system can apply a conversion function 912 to each of the error distributions 910 to generate converted error distributions 914.

Example 900B shows a graphical representation of the confidence-boosted automated valuation system performing confidence binning on test data as described more in detail above, for example, in relation to process 600 of FIG. 6. Example 900A includes test data 922 corresponding to homes with past sales. Example 900A shows the confidence-boosted automated valuation system generating confidence scores 932 or predicted errors of sold homes by applying a trained confidence model or error model 918 to the test data 922. Example 900A shows the confidence-boosted automated valuation system identifying/generating confidence bins (element 924) for the confidence scores 932. The confidence-boosted automated valuation system can first rank the confidence scores 932 into the ranked confidence scores 926. The confidence-boosted automated valuation system can either identify or generate the confidence bins 928 for the ranked confidence scores (e.g., bin_1, bin_2, bin_3, . . . , bin_20). When identified, the confidence bins 928 can be the same bins as confidence bins 908. When generated, the confidence bins 928 can be entirely new confidence bins. The confidence-boosted automated valuation system can then compute/generate error distributions 930 for the confidence bins 928. After generating the error distributions 930, the confidence-boosted automated valuation system can apply the conversion function 912 to each of the error distributions 930 to generate converted error distributions 934.

Example 900C shows a comparison of homes in a confidence bin with a wider converted error distribution 950 and homes in a confidence bin with a narrower converted error distribution 952. The conversion function 912 can convert initially wider error distribution 960 to have fewer homes fall under a 10% predicted error or confidence score threshold 970. The conversion function 912 can convert initially narrower error distribution 962 to have more homes or all homes still fall under a 10% predicted error or confidence score threshold 970. In other words, the conversion function 912 can penalize initially wider error distributions to have fewer homes eligible as confident homes, while allowing initially narrowing error distributions to have more homes eligible as confident homes. The parameters and constants of the conversion function can be learned from historical data or training data to compute desirable/target converted error distributions (e.g., the aforementioned converted wider and narrower error distributions). By performing this conversion, the confidence-boosted automated valuation system can ensure that only those homes in confidence bins with less spread or variance in confidence scores can be more likely to have confident home values. More details on the error threshold are described in detail above in relation to act 628 of process 600 in FIG. 6.

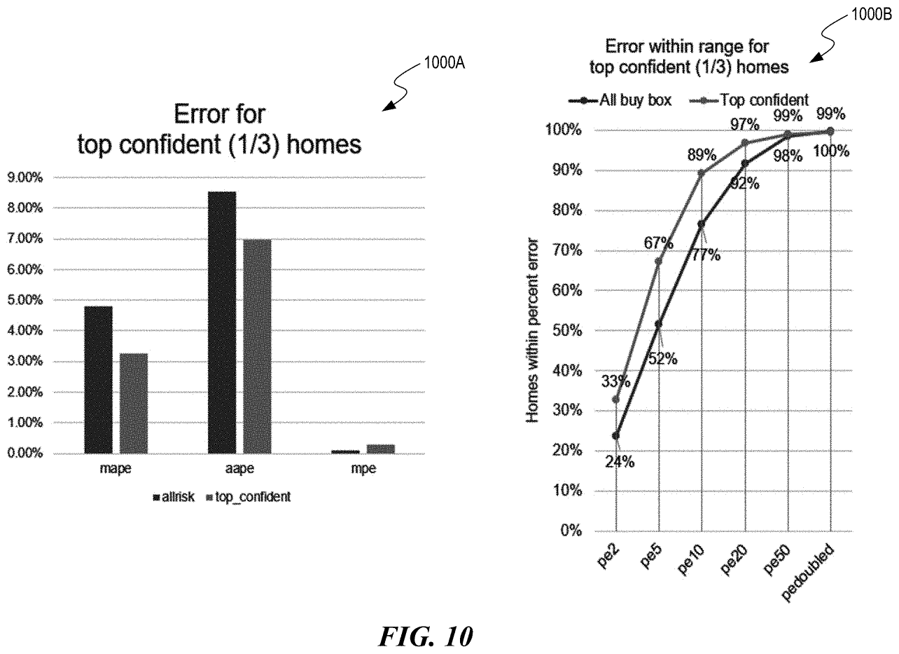

FIG. 10 is a conceptual diagram illustrating examples 1000A and 1000B of the errors of confident home values in accordance with some implementations of the present technology. Example 1000A shows that by filtering homes via an error threshold, e.g., described in relation to act 628 of process 600 in FIG. 6, the remaining top confident homes (e.g., ⅓ of remaining homes) have a smaller median absolute percent error and average absolute percent error in their predicted values than that of all homes unfiltered. Example 1000B shows that by filtering homes via an error threshold, the remaining top confident homes more homes within the percent errors of 2, 5, 10, 20, 50, and 100.

FIG. 11 is a conceptual diagram illustrating an example of a graphical representation 1100 of a confident home value offering 1104 in accordance with some implementations of the present technology. The confident home value 1104 can be provided at act 636 of process 600 in FIG. 6. In some implementations, the confidence-boosted automated valuation system can provide the confident home value 1140 by generating the graphical representation 1100 of the confident home value 1104 on a user-interface of a user device. The user device can be computing device 1104 (e.g., laptop, desktop computer, server, display), a mobile device 1106 (e.g., smartphone, tablet, VR/AR headset), or any of the devices 100 described in relation to FIG. 1. In some instances, the user device can be associated with a seller/buyer requesting an offer for a subject home. In various implementations, the confidence-boosted automated valuation system can provide the confident home value 1104 by first transmitting the confident home value 1104 to the user device. The confidence-boosted automated valuation system can then generate, on the user-interface of the user device, the graphical representation 1100 of the confident homes value. In various implementations, the confidence-boosted automated valuation system can be triggered to execute process 600 and/or provide the confident home value 1104 upon the graphical user interface (GUI) element 1102 being selected by a user entity (e.g., seller/buyer entity requesting an offer for a subject home by clicking on the GUI element 1102).

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples: alternative embodiments may employ differing values or ranges.

The teachings of the technology provided herein can be applied to other systems, not necessarily the system described above. The elements and acts of the various examples described above can be combined to provide further embodiments of the technology. Some alternative embodiments of the technology may include not only additional elements to those embodiments noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

We claim:

1. A system for performing confident processing of disparate valuations from distributed automated valuation models comprising:
at least one processor;
at least one memory coupled to the at least one processor and storing instructions that, when executed by the at least one processor, perform operations comprising:
identifying a set of homes to be used in training a confidence model;
for each particular home in the set of homes:
accessing a remotely connected home data store to obtain:
(1) home data describing features of the particular home;
(2) actual values of comparable homes for the particular home; and
(3) a predicted value of the particular home generated by one or more distributed valuation models trained to predict an actual value of the particular home;
accessing a remotely connected model data store to obtain model data associated with training and/or testing the one or more valuation models; and
generating a confidence score for the obtained predicted value of the particular home using the obtained actual values of the comparable homes and the predicted value of the particular home,
wherein the confidence score represents a degree of confidence in the predicted value of the particular home being the actual value of the particular home;
training the confidence model to produce confidence scores by:
generating model inputs using: (1) the obtained home data; (2) the obtained model data; and (3) the generated confidence scores of the particular homes; and
fitting the confidence model to the generated model inputs and updating parameters of the confidence model;
partitioning the set of homes into confidence bins each containing a subset of the set of homes with similar confidence scores,
wherein each confidence bin comprises bin threshold values that define bounds of the confidence bin;
for each confidence bin, computing, using a conversion function based on historical empirical conversion data, a converted error distribution for the confidence scores of the subset of homes in the confidence bin;
identifying a subject home to predict a confidence for using the trained confidence model;
accessing the remotely connected home data store to obtain: (1) subject home data and (2) a predicted value of the subject home;
generating a confidence score for the obtained predicted value of the subject home by:
generating model input using: (1) the obtained subject home data; (2) the model data; and (3) the predicted value of the subject home; and
applying the confidence model, trained to produce the confidence scores, to the generated model input;
identifying a confidence bin the subject home falls within using the confidence score of the subject home;
determining a predicted error in the predicted value of the subject home using the converted error distribution of the identified confidence bin;
determining that the predicted error does not exceed an error threshold; and
upon determining that the predicted error does not exceed the error threshold, providing the predicted value of the subject home as a confident home value.

2. The system of claim 1, wherein the operations further comprise:
accessing the remotely connected home data store to obtain: (1) a first predicted value of a first home generated by a first valuation model, and (2) a second predicted value of a second home generated by a second valuation model, wherein the first home is the subject home;
generating a first confidence score for the first predicted value using a first confidence model associated with the first valuation model,
wherein the first confidence model is the trained confidence model;
generating a second confidence score for the second predicted value using a second confidence model associated with the second valuation model; and
processing the first predicted value, the first confidence score, the second predicted value, and/or the second confidence score to produce one or more updated confidence scores and/or predicted values.

3. The system of claim 2, wherein processing to produce the one or more updated confidence scores and/or the predicted values comprises:
generating a calibrated first confidence score by applying a first calibration model, trained to calibrate the confidence scores, to the first confidence score; and
generating a calibrated second confidence score by applying a second calibration model, trained to calibrate the confidence scores with a similar calibration standard as that of the first calibration model, to the second confidence score,
wherein the one or more updated confidence scores comprise the calibrated first and second confidence scores.

4. The system of claim 3,
wherein the first calibration model is a first isotonic regression trained on similar training data as that of the first confidence model or the first valuation model, and
wherein the second calibration model is a second isotonic regression trained on similar training data as that of the second confidence model or the second valuation model.

5. The system of claim 2, wherein processing to produce the one or more updated confidence scores and/or the predicted values comprises:
using a confidence selector model, selecting a most confident predicted value from the first and second predicted values by:
generating model input for the confidence selector model using:
(1) the first and second confidence scores,
(2) home data and model data associated with the first and second valuation models,
(3) error distributions associated with the first and second confidence scores, and
applying the confidence selector model, trained to select most confident predicted values, to the generated model input for the confidence selector model;
wherein the one or more updated predicted values comprise the most confident predicted value.

6. The system of claim 5, wherein generating the model input for the confidence selector model further uses:
(1) a third confidence score generated from an ensemble of the first and second confidence models,
(2) home data and model data associated with an ensemble of the first and second valuation models, and
(3) an error distribution associated with the third confidence score.

7. The system of claim 2, wherein processing to produce the one or more updated confidence scores and/or the predicted values comprises:
accessing the remotely connected home data store to obtain: a third predicted value of a third home generated by a third valuation model,
identifying remaining predicted values by filtering, based on the first, second, and third confidence scores, at least one predicted value out of the first, second, and third predicted values; and
determining an updated predicted value by synthesizing the remaining predicted values.

8. The system of claim 7, wherein the synthetization is a mean, median, weighted mean, a weighted median, or other measure of central tendency of the remaining predicted values.

9. The system of claim 2,
wherein the first valuation model is a not-easily-explainable model,
wherein the second valuation model is an explainable model, and
wherein the processing to produce the one or more updated confidence scores and/or the predicted values further comprises:
determining whether to provide the second valuation model as a confident valuation model based on the first confidence score and the second confidence score.

10. The system of claim 9, wherein processing to produce the one or more updated confidence scores and/or the predicted values further comprises:
determining to provide the second valuation model as the confident valuation model when the first predicted value is confident, the second confidence score is not confident, and the second predicted value is within a predefined range of the first predicted value.

11. The system of claim 9, wherein processing to produce the one or more updated confidence scores and/or the predicted values comprises:
determining not to provide the second valuation model as the confident valuation model when the first predicted value is confident, the second confidence score is not confident, and the second predicted value is not within a predefined range of the first predicted value.

12. The system of claim 1, wherein providing the predicted value comprises:
transmitting the confident home value to a user device;
causing generation of, on a user-interface of the user device, a graphical representation of the confident home value.

13. The system of claim 1, wherein the operations further comprise:
receiving a request, transmitted from a user device, for a valuation of the subject home,
wherein identifying the subject home to predict the confidence for is performed upon receiving the request.

14. The system of claim 1,
wherein the actual values of the comparable homes comprise: an actual value at a first quantile of the comparable homes and an actual value at a second quantile of the comparable homes; and
wherein generating the confidence score for the obtained predicted value of the particular home comprises:
computing a difference between the actual value at the first quantile and the actual value at the second quantile; and
computing the confidence score as the difference divided by the predicted value of the particular home.

15. The system of claim 1, wherein the bin threshold values of the confidence bins are based on: a market or location the particular home is in, a time or season, a type of the particular home, and/or the home data.

16. The system of claim 1, wherein the operations further comprise:
identifying the bin threshold values that result in the confidence bins having good sample sizes and/or yielding realizable error distributions.

17. The system of claim 16, wherein evaluating the performance of the confidence bins comprises:
determining a number of confident homes in the one or more test homes; and
determining that the number of confident homes with predicted values within a predefined range of the actual value of the confident home exceeds a predefined threshold.

18. The system of claim 1, wherein the actual value is a sale price, a listing price, an inferred sale price, or an adjusted sale price.

19. At least one non-transitory, computer-readable medium carrying instructions, which when executed by at least one data processor, performs operations comprising:
for each particular home in a set of homes:
accessing one or more remotely connected data stores to obtain: (1) home data; (2) model data; (3) a predicted value of the particular home; and (4) actual values associated with the particular home; and
generating a confidence score for the obtained predicted value of the particular home using the obtained actual values and the predicted value;
training the confidence model to produce confidence scores using: (1) the obtained home data; (2) the obtained model data; and (3) the generated confidence score;
partitioning the set of homes into confidence bins each containing a subset of the set of homes with similar confidence scores;
computing an error distribution for each confidence bin;
accessing the one or more remotely connected data stores to obtain: (1) subject home data and (2) a predicted value of a subject home;
generating a confidence score for the obtained predicted value of the subject home by applying the trained confidence model to the subject home data and the predicted value of the subject home;
identifying a confidence bin for the subject home using the confidence score of the subject home; and
determining a predicted error in the predicted value of the subject home using the computed error distribution of the identified confidence bin.

20. A method for performing confident processing of disparate valuations from distributed automated valuation models comprising:
for each particular home in a set of homes:
accessing one or more remotely connected data stores to obtain: (1) home data; (2) model data; (3) a predicted value of the particular home; and (4) actual values associated with the particular home; and
generating a confidence score for the obtained predicted value of the particular home using the obtained actual values and the predicted value;
training the confidence model to produce confidence scores using: (1) the obtained home data; (2) the obtained model data; and (3) the generated confidence score;
partitioning the set of homes into confidence bins each containing a subset of the set of homes with similar confidence scores;
computing an error distribution for each confidence bin;
accessing the one or more remotely connected data stores to obtain: (1) subject home data and (2) a predicted value of a subject home;
generating a confidence score for the obtained predicted value of the subject home by applying the trained confidence model to the subject home data and the predicted value of the subject home;
identifying a confidence bin for the subject home using the confidence score of the subject home; and
determining a predicted error in the predicted value of the subject home using the computed error distribution of the identified confidence bin.
